(19) United States
(12) Patent Application Publication
(10) Pub. No.: US 2006/0169085 A1
(43) Pub. Date: Aug. 3, 2006

(54) Drive train comprising a device for selecting driving mode ranges of an automated manual transmission or automatic tansmission of a motor vehicle

(76) Inventor: Carsten Peuster, Esslingen (DE)

Correspondence Address: WILLIAM COLLARD;COLLARD & ROE, P.C., 1077 NORTHERN BOULEVARD, ROSLYN, NY, 11576, US

(21) Appl. No.: 10/531,904

(22) PCT Filed: Oct. 8, 2003
(86) PCT No.: PCT/EP03/11104

§ 371 Date: Oct. 27, 2005

(30) Foreign Application Priority Data
Oct. 18, 2002 (DE) 102-48-651.4

(51) Int. Cl. B60K 17/04

(52) U.S. Cl. 74/473.12

(57) ABSTRACT

1. A drive train with a selection device (4) for the selection of driving mode ranges of an automated manual transmission or of an automatic transmission for a motor vehicle. 2.1. Known selection devices which are designed as selector levers in the region of the vehicle tunnel or as steering column gearshifts occupy an inner space and require additional distances to be covered by the driver's hands which normally rest on the steering wheel. Furthermore, the selector lever and the steering column gearshift project into the interior of the passenger cell, with the result that unwanted faulty operations are possible.

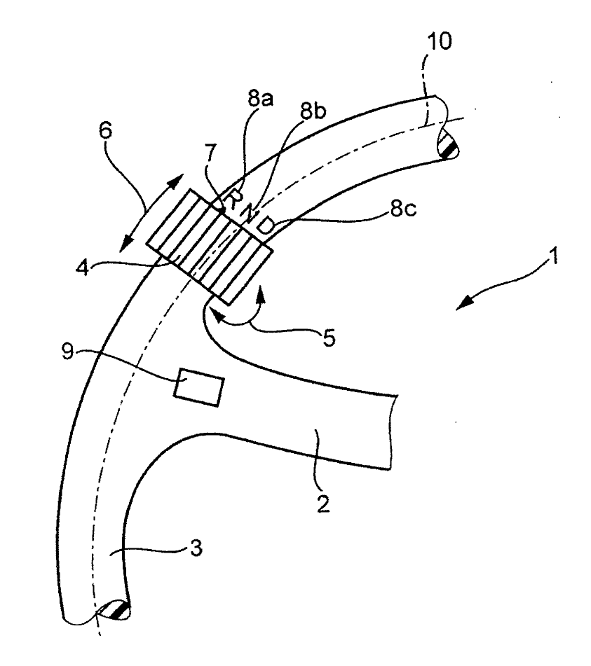

2.2. According to the invention, a selection device (4) for the selection of driving mode ranges is proposed, which is arranged on the steering wheel (1) of the motor vehicle and, for operation, is moved rotationally about the steering wheel rim (3) of the steering wheel (1) and/or along the steering wheel rim (3). Moreover, the selection device (4) can be displaced along the steering wheel rim (3) into a position for a favorable grip and be designed as a switch or push button or as a combination thereof. 2.3. The invention is suitable particularly for the selection of driving mode ranges of an automated manual transmission or of an automatic transmission.

The invention relates to a drive train with a selection device for the selection of driving mode ranges of an automated manual transmission or of an automatic transmission for a motor vehicle according to the preamble of patent claim 1.

Known selection devices for presetting a driving mode range PRND are conventionally designed as selector levers in the region of the vehicle tunnel, cf., for example, DE 40 05 588 A1.

Alternatively, a selection device is designed as a steering column gearshift, cf., for example, EP 1 045 172 A2, U.S. Pat. No. 6,076,414, EP 0 132 256 B1, DE 43 05 903 A1, EP 0 432 507 B1 and DE 198 28 039 A1.

The invention is based on the recognition that both the selector lever arranged in the region of the vehicle tunnel and the steering column gearshift occupy, in the passenger cell, an inner space which is to be saved for esthetic reasons, for simplification and/or for the arrangement of other components in this region.

Furthermore, the invention is based on the recognition that the operation of the selector lever and of the steering column gearshift, both during the starting of the motor vehicle and when the latter is in operation, requires additional distances to be covered by the driver's hands which normally rest on the steering wheel. Moreover, the selector lever and the steering column gearshift project into the interior of the passenger cell, with the result that unwanted faulty operations are possible.

According to the invention, therefore, it is proposed that the selection device be arranged on the steering wheel itself, in particular as an integral part of the latter. As a result, construction space is saved and the abovementioned faulty operation is avoided. An actuation of the selection device takes place by means of a rotational movement about a steering wheel rim of the steering wheel. Such a degree of freedom of movement can be implemented in a simple, but space-saving way by mounting with respect to the steering wheel rim. Moreover, the driver can easily operate a selection device of this type. Furthermore, the driver does not have to remove his hands from the steering wheel in order to actuate the selection device.

The invention, then, is explained by means of an exemplary embodiment, with reference to the drawing.

The single FIGURE shows diagrammatically part of a steering wheel of a motor vehicle with a selection device according to the invention arranged in the steering wheel rim.

The FIGURE shows a steering wheel 1 consisting of one or more steering wheel spokes 2 and of a steering wheel rim 3 having a (circumferential) axis 10. The steering wheel rim 3 has arranged on it a selection device 4 according to the invention for the selection of various gears, shift programs or driving mode ranges for an automated manual transmission or an automatic transmission. The selection device 4 is connected to following actuators in the transmission by means of electrical connecting lines which run in the steering wheel 1 in a known way. Instead of the electrical connecting lines, radio signals may also be used.

Preferably, the selection device 4 is designed as a ring rotatable about the (circumferential) axis 10 or displaceable along the (circumferential) axis 10 or as a combination thereof and has a marking, a notch or a nose 7 which, in the case of a specific gear, shift program or driving mode range, points to a corresponding symbol 8a, 8b, 8c printed onto the steering rim 3 or embossed into the steering wheel rim 3 or causes such a symbol 8a, 8b, 8c to become visible.

In particular, when a steering wheel 1 is not subjected to any steering lock, for example in the case of uniform motorway travel, the selection device 4 is in the 6 o'clock position or in the 10 o'clock or 2 o'clock position. Preferably, the selection device 4 can be displaced along the steering wheel rim 3 into a position favorable for the specific driver's grip, so that it can be operated, for example, with the right or left hand. However, this displacement of the selection device 4 into a position for a favorable grip is to be possible only with somewhat greater effort or only after the release of a lock, since there is otherwise the risk that the selection device 4 is displaced unintentionally, for example during the shift of a gear, shift program or driving mode range.

Preferably, the contour or cross section of the selection device 4 in the neutral or middle position corresponds largely to the contour or cross section of the adjacent steering wheel rim 3 and deviates from this in another position, so that the driver detects whether the neutral or middle position is set.

To select a specific gear, shift program or driving mode range, the selection device 4 is pivoted rotationally about the steering wheel rim 3 according to a turn 5 or is displaced along the steering wheel rim 3 in the direction 6, or both in combination. As illustrated, the selection device 4 may in this case have as a plurality of stable positions, for example in each case a position for the driving mode ranges “P” (park), “R” (reverse), “N” (neutral), “D” (drive), if appropriate also “1” (only first gear), “2” (only first and second gear), etc. within the driving mode range “D”, be designed with two unstable outer or shift positions and one stable middle position, or, again, both in combination.

A first exemplary embodiment is obtained when said driving mode ranges are set by the selection device 4 being pivoted rotationally about the steering wheel rim 3 according to the turn 5, and the optional manual sequential shifting of the gears takes place by means of the displacement of the selection device 4 along the steering wheel rim 3 in the direction 6, pivoting taking place rotationally into a plurality of fixed switch positions, and the selection device 4 being designed as a pushbutton for optional upshifting and downshifting.

In a second exemplary embodiment, said driving mode ranges are set by means of the displacement of the selection device 4 along the steering wheel rim 3 in the direction 6 and the optional manual sequential shifting of the gears is carried out by the selection device 4 being pivoted rotationally about the steering wheel rim 3 according to the turn 5, the selection device 4 being designed again as a push button for optional upshifting and downshifting rotationally in the direction of the turn 5, and each driving mode range corresponding to a fixed switch position in the direction 6.

Alternatively to the switch or push button movable in the two actuation directions according to the turn 5 and in the direction 6, the selection device 4 may also be designed as a two-part or three-part ring, a first part of the ring making it possible, for example, to select a shift program, for example summer, winter or sports operation, a second part making it possible to select one of the driving mode ranges already mentioned, and the third part allowing optional upshifting or downshifting in manual mode, or as a combination thereof.

Or the selection device 4 serves merely for selecting the desired driving mode range, and the desired shift program or a gear is set, for example, by means of shift rockers or pressure switches 9 which are arranged, preferably for a favorable grip, in the transition between a steering wheel spoke 2 and the steering wheel rim 3.

Furthermore, the selection of gears, shift programs or driving mode ranges may take place by means of a combination of the selection device 4 described on the steering wheel 1 and further shift or selection buttons on the steering wheel 1, or in combination with a conventional selector lever.

A contribution to increased safety is made when the selection device 4 can be shifted out of a parking position P or a neutral position N into a driving mode range D or R only when the motor vehicle is at rest, and, conversely, another position of the selection device 4 out of the driving mode range D or R can be selected only when the motor vehicle is (again) at a standstill.

The extent of the selection device 4 in the circumferential direction corresponds, in particular, to at least the width of a driver's hand.

1. A drive train, with a selection device (4) for the selection of driving mode ranges of an automated manual transmission or of an automatic transmission for a motor vehicle, wherein the selection device (4) is arranged on the steering wheel (1) of the motor vehicle, and an actuation of the selection device (4) for selecting the driving mode range takes place by means of a rotational movement about a steering wheel rim (3) of the steering wheel (1).

2. The drive train with a selection device (4) as claimed in claim 1, wherein, in addition to the presetting of the driving mode range, the selection device (4) also serves for selecting a gear and/or a shift program.

3. The drive train with a selection device (4) as claimed in claim 1, wherein an actuation of the selection device (4) takes place additionally by means of displacement along the steering wheel rim (3).

4. The drive train with a selection device (4) as claimed in claim 1, wherein the selection device (4) has a plurality of stable positions.

5. The drive train with a selection device (4) as claimed in claim 1, wherein the selection device (4) has two unstable outer or shift positions and at least one stable middle position.

6. The drive train with a selection device (4) as claimed in claim 1, wherein the selection device (4) is designed as a combination of a latching switch and push button.

7. The drive train with a selection device (4) as claimed in claim 1, wherein the selection device (4) is designed, in the direction rotationally about the steering wheel rim (3), with a plurality of stable positions and, in the direction along the steering wheel rim (3), with two unstable outer or shift positions and at least one stable middle position.

8. The drive train with a selection device (4) as claimed in claim 1, wherein the selection of the driving mode range takes place by means of a rotational movement about the steering wheel rim (3) and the selection of a gear or of a shift program takes place by means of the displacement of the selection device (4) along the steering wheel rim (3).

9. The drive train with a selection device (4) as claimed in claim 1, wherein the selection device (4) is designed as a one-part or two-part ring.

10. The drive train with a selection device (4) as claimed in claim 1, wherein the ring or each part of the ring has a marking, a nose or a notch (7).

11. The drive train with a selection device (4) as claimed in claim 10, wherein, in the case of a specific gear, shift program or driving mode range, the marking, nose or notch (7) points to a corresponding symbol (8a-c) printed onto the steering wheel rim (3) or embossed into the steering wheel rim (3) or causes such a symbol (8a-c) to become visible.

12. The drive train with a selection device (4) as claimed in claim 1, wherein the selection device (4) can be displaced along the steering wheel rim (3) into a position most favorable for the specific driver's grip.

13. The drive train with a selection device (4) as claimed in claim 12, wherein the displacement of the selection device (4) along the steering wheel rim (3) is possible only with somewhat greater effort or only after the release of a lock.

14. The drive train with a selection device (4) as claimed in claim 1, wherein, in a neutral or middle position, the contour or cross section of the selection device (4) corresponds largely to the contour or cross section of the adjacent steering wheel rim (3) and deviates from this in another position.

15. The drive train with a selection device (4) as claimed in claim 1, wherein the selection of gears, shift programs or driving mode ranges takes place by means of a combination of the selection device (4) and shift or selection buttons (9) on the steering wheel (1) or a conventional selector lever.

16. The drive train with a selection device (4) as claimed in claim 1, wherein the selection device (4) is connected to following actuators in the transmission for-signal transfer by means of electrical connecting lines which run in the steering wheel (1).

17. The drive train with a selection device (4) as claimed in claim 16, wherein signal transfer between the selection device (4) and the following actuators takes place by means of radio signals.

18. The drive train with a selection device (4) as claimed in claim 1, wherein the selection device (4) can be shifted out of a parking position into a driving mode range only when the motor vehicle is at rest.
